(19) United States
(12) Patent Application Publication
(10) Pub. No.: US 2005/0194878 A1
(43) Pub. Date: Sep. 8, 2005

(54) Spark plug

(75) Inventor: Tetsuya Watanabe, Okazaki-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/068,385

(22) Filed: Mar. 1, 2005

(30) Foreign Application Priority Data
Mar. 3, 2004 (JP) 2004-59040

(51) Int. Cl. H01T 13/20

(52) U.S. Cl. 313/141; 313/143

(57) ABSTRACT

A spark plug includes a metal shell, a center electrode secured in the metal shell and isolated from the metal shell, a ground electrode joined to the metal shell. A Pt-based chip joined to at least one of confronting portions of the center electrode and the ground electrode. The Pt-based chip has a granulated crystal structure. A range of an average grain diameter of the Pt-based chip is defined through experimental investigation so as to suppress an accumulation of crystal grains in a spark gap of the spark plug.

### CROSS REFERENCE TO RELATED APPLICATION

This application is based on Japanese Patent Application No. 2004-059040 filed on Mar. 03, 2004, the disclosure of which is incorporated herein by reference.

### FIELD OF THE INVENTION

The present invention relates to spark plugs for internal combustion engines of automobile, cogeneration, gas pump and so on. More particularly, the invention relates to a spark plug having a Pt(Platinum)-based chip.

### BACKGROUND OF THE INVENTION

Spark plugs generally include a metal shell, a center electrode secured in the metal shell and a ground electrode joined to the metal shell. It has been known for a spark plug to include a Pt-based chip joined to at least one of the confronting portions of the center electrode and the ground electrode.

In addition, for the purpose of long service life, a spark plug has been proposed which includes a Pt-based chip having a stratified crystal structure in order to suppress consumption of the Pt-based chip (for example, Japan unexamined patent publication No. H8-37082).

Spark plugs for gas engines are exposed to high temperature atmosphere for a long time as compared to spark plugs for automobile. Furthermore, spark plugs for gas engines having a small spark gap as compared to spark plugs for automobile. When the spark plug proposed in Japan unexamined patent publication No. H8-37082 is exposed to high temperature atmosphere for a long time, A short-circuit occurs in the spark plug caused by an accumulation of crystal grains of the spark gap.

### SUMMARY OF THE INVENTION

It is, therefore, an object of the present invention to provide a spark plug having an improved structure which has high heat resistance and durability in order to suppress an accumulation of crystal grains in the spark gap.

According to one aspect of the invention, there is provided a spark plug which comprises: a metal shell; a center electrode secured in the metal shell and isolated from the metal shell; a ground electrode joined to the metal shell; a Pt-based chip joined to at least one of confronting portions of the center electrode and the ground electrode; and wherein the Pt-based chip has a granulated crystal structure and has an average grain diameter in a range from 15 to 45 μm.

At first, the reason for employing the granulated crystal structure in accordance with the inventor in order to suppress a decrease in bonding force in grain boundaries is described.

The inventor of the present invention surmises that exposure to high temperature atmosphere for a long time causes oxidation of grain boundaries in a Pt-based chip, which induces a decrease in bonding force at grain boundaries. Consequently, crystal grains dropped due to cracks in grain boundaries or peeled off by spark, are accumulated in the spark gap. More specifically, when the Pt-based chip is exposed to high temperature atmosphere for a long time, the stratified crystal structure of the Pt-based chip is recrystallized. In this recrystallization the Pt-based chip changes from a stratified crystal structure as shown in FIG. 3 to a granulated crystal structure as shown in FIG. 4. The inventor surmises that, when the spark plug is used in an internal combustion engine, oxygen existing outside of the Pt-based chip gets into grain boundaries of the Pt-based chip, so that the oxidation of the grain boundaries induces a decrease in the bonding force at the grain boundaries. The inventor thought that it is important to prevent the oxidation of the grain boundaries when the Pt-based chip changes from a stratified crystal structure to a granulated crystal structure. Therefore, the inventor employs a Pt-based chip having a granulated crystal structure at the outset. The Pt-based chip having a granulated crystal structure is not recrystallized, so that oxidation of grain boundaries is suppressed in the Pt-based chip. A Pt-based chip having a granulated crystal structure as used in this specification means the Pt-based chip has a granulated crystal structure before the Pt-based chip is used in an internal combustion engine.

However, the inventor found out that only employing the Pt-based chip having a granulated crystal structure is insufficient for suppressing the short-circuit between electrodes. Accordingly, the inventor considered an average grain diameter of the Pt-based chip.

The crystal grain of the Pt-based chip become gradually rough and large while the Pt-based chip is exposed to high temperature atmosphere. The Pt-based chip having rough and large crystal grain has less bonding force at the grain boundaries. Furthermore the grain boundaries between rough and large crystal grains are easily oxidizable in a high temperature atmosphere and have less fatigue strength. Cracks caused by grain boundaries fracture will occur in the Pt-based chip having less bonding force between grain boundaries under heat stress conditions. If the Pt-based chip is exposed to such a condition for a long time, crystal grains will drop from the Pt-based chip. Accordingly, the inventor realized it is important to minimize an initial average grain diameter. Therefore, in order to suppress dropping of crystal grains caused by a decrease in bonding force at the grain boundaries, the inventor employs a Pt-based chip having an average grain diameter of equal to or less than 45/m. Because dropping of crystal grain will occur in a Pt-based chip having an average grain diameter of more than 45 μm.

On the other hand, in the case that the Pt-based chip has a small average grain diameter, crystal grains on the surface of the Pt-based chip are peeled off by spark. The crystal grains peeled off are accumulated on the Pt-based chip along the sparking path. The inventor experimentally found out the relationship between accumulation of the crystal grains in the spark gap and an average grain diameter. The inventor also found out that the Pt-based chip having an average grain diameter in more than 15 μm efficiently suppresses a short-circuit in the spark gap.

The Pt-based chip having an average grain diameter in a range from 15 to 45 μm as used in this specification means the Pt-based chip has such an average grain diameter before the Pt-based chip is used in an internal combustion engine. It is easy to manage the average grain diameter before the Pt-based chip is used in an internal combustion engine, since the average grain diameter changes by heat.

Therefore, the Pt-based chip embodying the invention has a granulated crystal structure and an average grain diameter in a range from 15 to 45 μm.

According to another embodiment of the present invention, the Pt-based chip has 100HV0.3 hardness or more. The inventor considered a relationship between hardness and dropping in order to suppress dropping. The dropping of crystal grains can be suppressed in a Pt-based chip having 100HV0.3 hardness or more. The 100HV0.3 hardness means that the Pt-based chip has 100-grade hardness when a test load of 0.3 kg is added to the Pt-based chip in the Vickers hardness test which is standardized in JIS (Japanese Industrial Standards) Z 2244.

According to an exemplary embodiment of the present invention, the Pt-based chip includes Pt in an amount of equal to or more than 50 weight percent as a first component and at least one additive selected from Ir, Re and W in a range from 3 to 25 weight percent as a second component. Ir, Re and W have higher melting points than Pt and have a characteristic of minimizing crystal grains in the Pt-based chip. The Pt-based chip including at least one additive selected from Ir, Re and W has high hardness, so that dropping is suppressed in the Pt-based chip. If the amount of Ir, Re and W is less than 3 weight percent, the hardness of the Pt-based chip does not become high. If the amount of Ir, Re and W is more than 25 weight percent, the Pt-based chip is too hard to manufacture, so that cracks will occur in the Pt-based chip, for example in the metal rolling process.

According to another exemplary embodiment of the present invention, the Pt-based chip further includes at least one additive selected from Ni, Fe, Co, Cr, Al, Ti, In, Rh and Cu as a third component, and an amount of atomic mass of the third component is less than three times an amount of atomic mass of the second component. Ni, Fe, Co, Cr, Al, Ti, In, Rh and Cu as a third component have the characteristic of forming stable oxides. Any of these components in the Pt-based chip forms oxidation films on the surface of the Pt-based chip, for example NiO, FeO, CoO, Cr₂O₃, Al₂O₃, TiO₂, In₂O₃, Cu₂O and Rh₂O₃. The oxidation films serve as a protection films and suppress the oxidation of grain boundaries. If the amount of atomic mass of the third component is more than three times the amount of atomic mass of the second component, a short-circuit will occur due to foamed molten metal regionally generated on the chip surface. Therefore, it is preferable that the amount of atomic mass of the third component is equal to or less than three times the amount of atomic mass of the second component.

According to yet another embodiment of the present invention, a spark gap formed between the center electrode and the ground electrode is in a range from 0.15 to 0.6 mm.

It is another object of the present invention to provide a method of manufacturing a spark plug having an improved structure which has high heat resistance and durability in order to suppress an accumulation of crystal grains in a spark gap.

According to one aspect of the invention, there is provided a method of manufacturing a spark plug having a metal shell, a center electrode secured in the metal shell and isolated from the metal shell, a ground electrode joined to the metal shell, a Pt-based chip joined to at least one of confronting portions of the center electrode and the ground electrode which comprises: forming a Pt-based chip having a stratified crystal structure; recrystallizing the Pt-based chip from a stratified crystal structure to a granulated crystal structure by heat treatment; and welding the Pt-based chip having a granulated crystal structure to at least one of confronting portions of the center electrode and the ground electrode.

### BRIEF DESCRIPTION OF THE DRAWINGS

The present invention will be understood more fully from the detailed description given hereinafter and from the accompanying drawings of the preferred embodiments of the invention, which, however, should not be taken to limit the invention to the specific embodiments but are for the purpose of explanation and understanding only.

In the accompanying drawings:

FIG. 1 is a partially cross sectional view showing a spark plug according to the present invention;

FIG. 2 is an enlarged side view showing a spark gap and the proximity thereof in the spark plug of FIG. 1;

FIG. 3 is an illustration for showing a stratified crystal structure of a Pt-based chip;

FIG. 4 is an illustration for showing a granulated crystal structure of a Pt-based chip;

FIG. 5 is an illustration for showing accumulation of crystal grains in a spark gap;

FIG. 6 is a graphical representation showing the result of the endurance test of a granulated crystal structure and a stratified crystal structure, respectively;

FIG. 7 is a graphical representation showing the relationship between the test time and the length of accumulation of crystal grains;

FIG. 8 is a graphical representation showing the relationship between the heat treatment temperature and the hardness of the Pt-based chip;

FIG. 9 is a graphical representation showing the relationship between the amount of Ni additive and the length L of accumulation of crystal grains;

FIG. 10 is a graphical representation showing the relationship between the amount of Cr additive and the length L of accumulation of crystal grains;

FIG. 11 is a graphical representation showing the relationship between the amount of Al additive and the length L of accumulation of crystal grains;

FIG. 12 is a graphical representation showing the relationship between the heat treatment temperature and the average grain diameter; and

FIG. 13 is a table showing the atomic mass.

### DETAILED DESCRIPTION OF EMBODIMENT

An embodiment of the present invention will be described hereinafter with reference to the drawings.

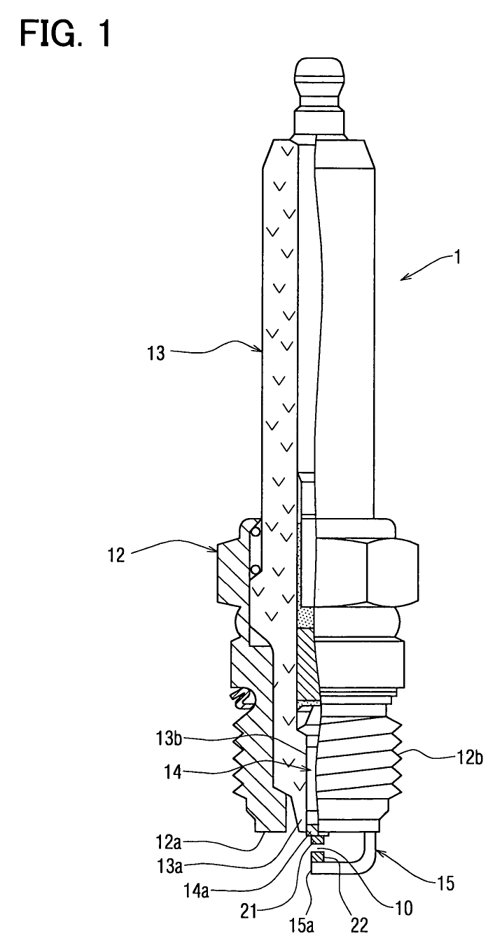

As shown in FIG. 1, a spark plug 1 includes a metal shell 12, a center electrode 14 secured in the metal shell 12 and isolated from the metal shell 12 through an insulator 13, a ground electrode 15 joined to a first end 12a of the metal shell 12.

The metal shell 12 has a cylindrical shape and a male thread 12b on an outer periphery thereof. The male thread 12b is used for fitting to a cylinder head of an internal combustion engine.

The insulator 13 is made of alumina ceramic (Al₂O₃) or other ceramic. The insulator 13 is secured in the metal shell 12 so that a first end 13a of the insulator 13 and the first end 12a of the metal shell 12 are approximately in one plane.

The cylindrical center electrode 14 is made of a highly heat conductive metal material such as Cu(Cupper) as the core material and a highly heat-resistant, corrosion-resistant metal material such as Ni(Nickel)-based alloy as the clad material. The center electrode 14 fixed in a center bore 13b formed in the insulator 13 so that the center electrode 14 protrudes from the first end 13a of the insulator 13.

The ground electrode 15, which is made of a Ni-based alloy, has an approximate L-shape. A second end of the ground electrode 15 is joined to the first end 12a of the metal shell 12 by welding. The ground electrode 15 has a confronting portion 15a facing to the first end 14a of the center electrode 14 through a spark gap 10.

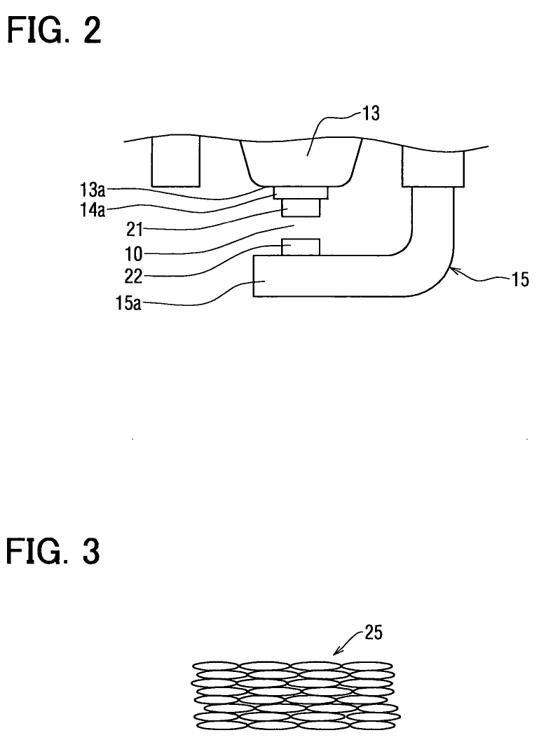

FIG. 2 is an enlarged side view showing a spark gap and the proximity thereof in the spark plug of FIG. 1 As shown in FIG. 2, a first Pt-based chip 21 and a second Pt-based chip 22 are joined to the first end 14a of the center electrode 14, which is one of the confronting portions, and the confronting portion 15a of the ground electrode 15, respectively.

The first Pt-based chip 21 and the second Pt-based chip 22 define the spark gap 10. The spark gap 10 has a clearance in a range from 0.15 to 0.6 mm, which is generally employed in spark plugs for gas engines. The first Pt-based chip 21 and the second Pt-based chip 22 have a granulated crystal structure and have an average grain diameter in a range from 15 to 45 μm. The average grain diameter in this specification means an average value of crystal grain diameters observed with a metallurgical microscope.

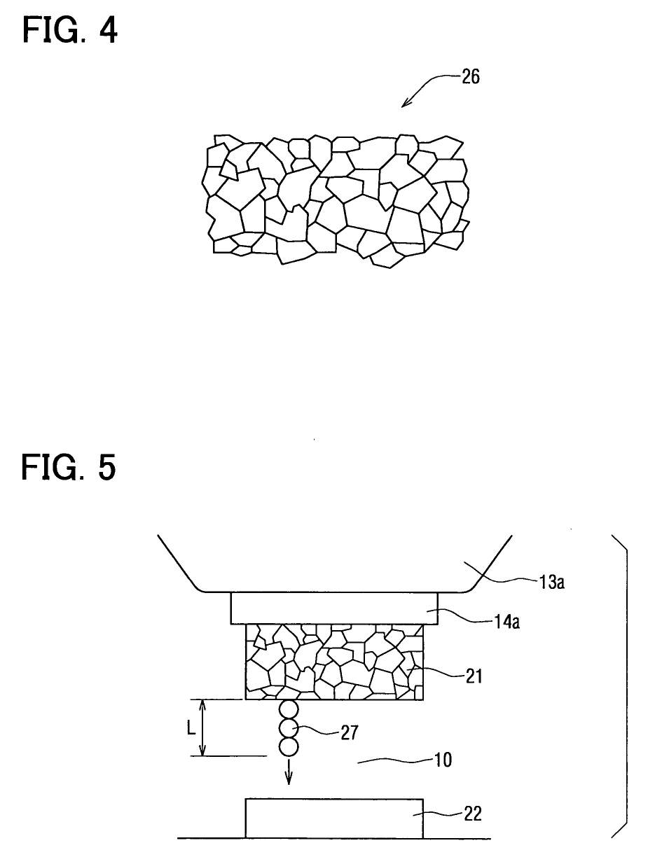

A method of manufacturing the spark plug 1 having the Pt-based chips 21 and 22 comprises three processes as described below. A first process of forming a Pt-based chip having a stratified crystal structure as shown in FIG. 3 comprises drawing a Pt-based metal by a drawing process and cutting a drawn Pt-based metal bar as a predefined length. The drawing process can be substituted for rolling process, forging process or the process combined drawing, rolling and forging. A second process of obtaining a Pt-based chip having a granulated crystal structure as shown in FIG. 4 comprises recrystallizing the Pt-based chip from a stratified crystal structure to a granulated crystal structure by heat treatment conducted under a condition of equal to or more than 1000 degree Celsius in a vacuum or an inactive gas atmosphere, for example argon gas atmosphere. A third process of obtaining a spark plug comprises welding the chip having a granulated crystal structure to at least one of confronting portions of the center electrode 14 and the ground electrode 15 by resistance welding.

The Pt-based chip 22 has 100HV0.3 hardness or more. Such hardness of the Pt-based chip suppresses dropping of crystal grains caused by cracks at grain boundaries due to heat stress. The Pt-based chips 21 and 22 are made of a Pt-based alloy including Pt in an amount of equal to or more than 50 weight percent as a first component and at least one additive selected from Ir, Re and W in a range from 3 to 25 weight percent as a second component. By specifying the components of the Pt-based chips, hardness of the Pt-based chips can be secured. Consequently, dropping of crystal grain can be suppressed.

The Pt-based chips 21 and 22 further include at least one additive selected from Ni, Fe, Co, Cr, Al, Ti, In, Rh and Cu as a third component. An amount of atomic mass of the third component is equal to or less than three times an amount of atomic mass of the second component. Since Ni, Fe, Co, Cr, Al, Ti, In, Rh and Cu are easily oxidizable metals, the Pt-based chips 21 and 22 form oxide films on the surface thereof. The oxide films suppress oxidation of grain boundaries, so that a decrease in bonding force at grain boundaries is suppressed in the Pt-based chips 21 and 22.

By the way, since the management by weight is generally easier than the management by atomic mass concerning the components of the Pt-based chip, the table shown in FIG. 13 can be used for converting from atomic mass to weight. For example, when the desirable ratio of atomic mass of Ni in relation to Ir is 0.916, the weight percent of Ni should be added to the Pt-based metal including Ir in 20 weight percent is calculated as below. In case that the ratio of atomic mass of Ni in relation to Ir is 0.916, the ratio is represented by formula (1).
Ir(at):Ni(at)=1:0.916 (1)

The weight ratio of Ir in relation to Ni is calculated as shown by formula (2).

$$\begin{matrix}Ir ( wt ) : Ni ( wt ) = 192.22 * 1 : 58.7 * 0.916 \\ = 192.22 : 53.77\end{matrix} \qquad ( 2 )$$

When the Pt-based metal includes Ir in 20 weight percent, the weight percent of Ni should be added is represented by formula (3).
20:Ni(wt %)=192.22:53.77
Ni(wt %)=53.77*20/192.22=5.6(wt %) (3)

Next, the advantage of the Pt-based chip of the present invention is described based on test results. The test was conducted under condition of 750 rpm, 100 percent engine load and 18 bar(1.8 MPa) mean effective pressure.

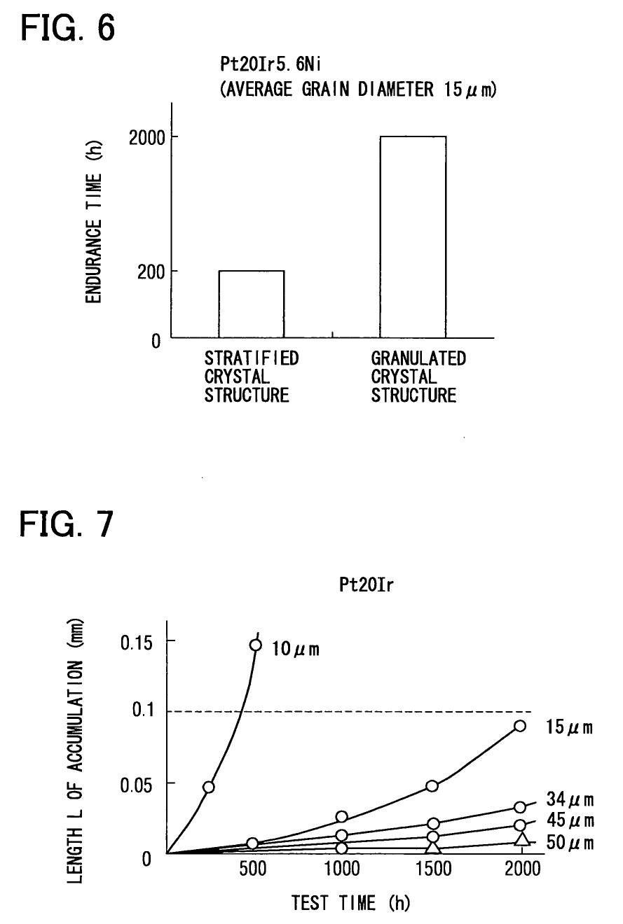

FIG. 6 shows the results of endurance test of the Pt-based chip having a granulated crystal structure and a stratified crystal structure, respectively. These Pt-based chips include Ir in 20 weight percent. When the Pt-based chip has a stratified crystal structure, a short-circuit occurred after 200 hours by an accumulation of crystal grains. On the other hand, when the chip has a granulated crystal structure and has an average grain diameter of 15 μm, the short-circuit did not occur after a 2000 hour test, although a little accumulation of crystal grains is observed due to oxidation of grain boundaries. Accordingly, A Pt-based chip having a granulated crystal structure suppresses an oxidation of grain boundaries.

FIG. 7 shows the relationship between the test time and the lengthLof accumulation of crystal grains. The Pt-based chips having a granulated crystal structure and including Ir in 20 weight percent are tested. The average grain diameter of the Pt-based chip is varied. The plots in FIG. 7 show average values of four tests. The symbol “Δ” indicates that at least one short-circuit occurred in four tests by dropping of the crystal grains. As shown in FIG. 7, when the average grain diameter is equal to or more than 15 μm, the length L is not more than 0.1 mm after a 2000 hour test, so that a short-circuit did not occur. Two thousand (2000) hours is the generally targeted service life of spark plugs for gas engines. A spark plug for gas engines generally has a minimum spark gap of 0.15 mm. When the length L is equal to or less than 0.1 mm after 2000 hours test, the spark gap in 0.05 mm is ensured. When an average grain diameter is equal to or less than 45 μm, dropping due to cracks did not occur. However, when average grain diameter is 50 μm, a short-circuit caused by dropping which is due to cracks at grain boundaries occurred. Therefore, the Pt-based chip having an average grain diameter in a range of 15 to 45 μm suppresses a short-circuit caused by an accumulation of Pt crystal grains peeled off by spark and dropped by cracks.

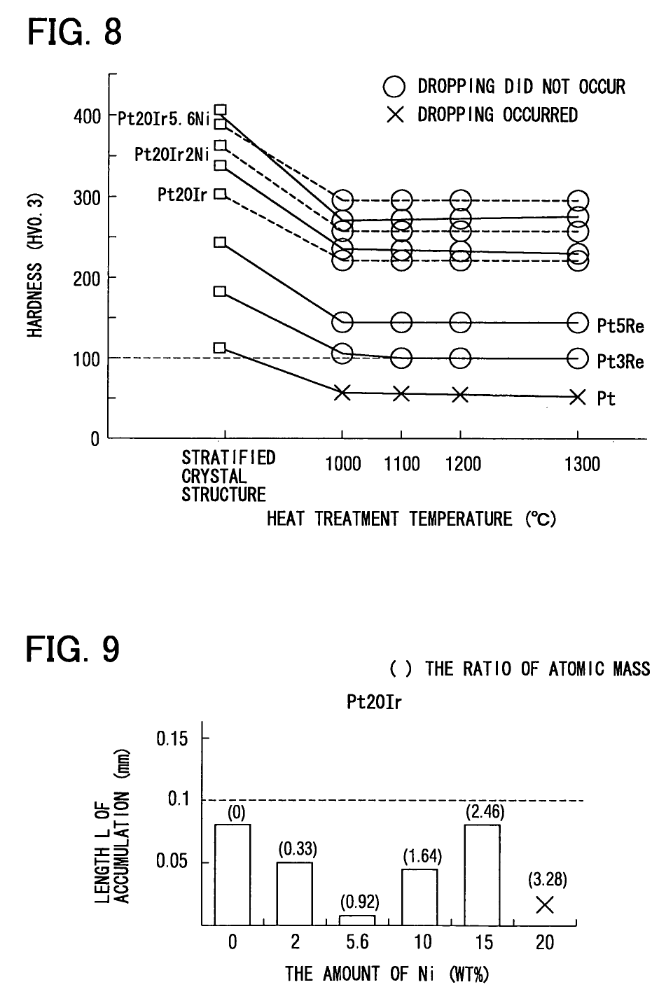

FIG. 8 shows the relationship between the heat treatment temperature and hardness of the Pt-based chip. The test results for a pure Pt chip, a Pt-based chip including Ir, a Pt-based chip including Re and a Pt-based chip including Ir and Ni are shown in FIG. 8. These chips are treated with heat for one hour, respectively. The temperature of heat treatment is varied, for example 1000, 1100, 1200 and 1300 degree Celsius. The symbol “ο” indicates dropping did not occur. The symbol “X” indicates dropping due to cracks at grain boundaries occurred in a 2000 hour test. As shown in FIG. 8, the hardness of chips decrease by recrystallization due to heat treatment. When the hardness is less than 100HV0.3, dropping occurred due to a decrease of hardness. When Ir or Re of equal to or more than 3 weight percent is added to the Pt-based chip, the 100HV0.3 hardness is ensured. When Ir and Ni are added to the Pt-based chip, the Pt-based chip becomes harder. However, when Ir or Re of more than 25 weight percent is added to the Pt-based chip, the chip is too hard to manufacture. It have not been seen the change by heat treatment. Consequently, dropping is suppressed in the Pt-based chip having 100HV0.3 hardness or more. Such hardness is provided by adding Ir or Re. W can be substituted for Ir or Re.

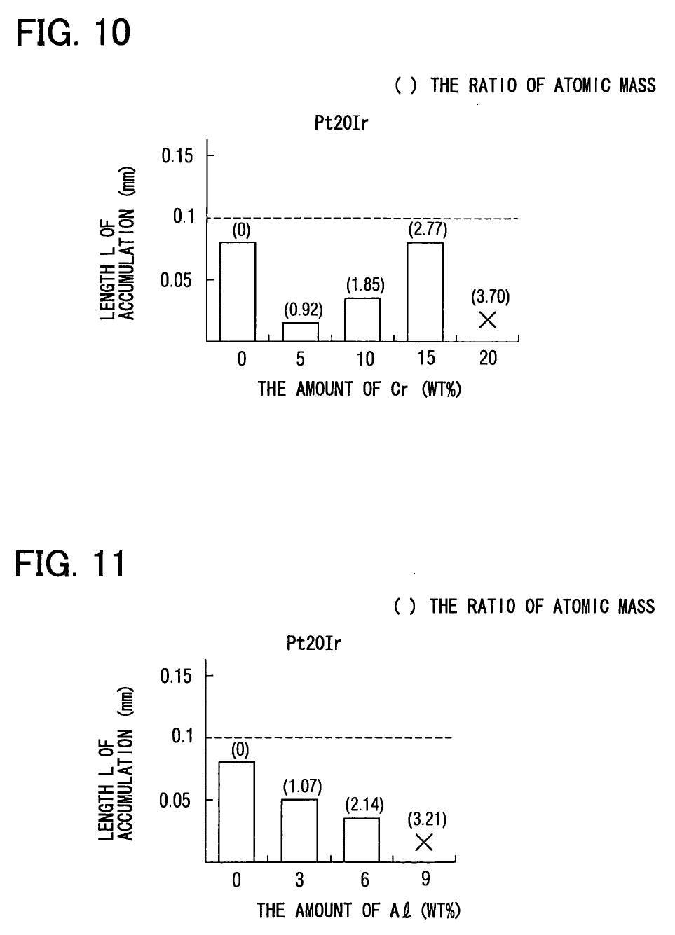

FIG. 9 shows the relationship between the amount of Ni additive in the Pt-based chip and the length of accumulation of crystal grains. The Pt-based chips include Ir in 20 weight percent and crystal grains having an average diameter of 15 μm. The atomic percent of Ni are shown in parentheses. When the atomic percent of Ni is close to 1, the length L is small. FIG. 10 shows the relationship between the amount of Cr additive and the length L of accumulation of crystal grains. FIG. 11 shows the relationship between the amount of Al additive and the length L of accumulation of crystal grains. In FIG. 9, FIG. 10 and FIG. 11 the symbol “X” indicates the occurrence of foamed molten metal on the chip surface. When the ratio of atomic mass is more than 3, the short-circuit occurred due to occurrence of foamed molten metal. As shown in FIG. 9, when the amount of Ni additive is 20 weight percent, the short-circuit occurred by an accumulation of 0.15 mm. When the amount of Ni additive is 0 to 15 weight percent, the length of an accumulation is not more than 0.1 mm, so that the short-circuit did not occur. As shown in FIG. 10, when the amount of Cr additive is 20 weight percent, the short-circuit occurred. When the amount of Cr additive is 0 to 15 weight percent, the length of an accumulation is not more than 0.1 mm, so that the short-circuit did not occur. As shown in FIG. 11, when the amount of Al additive is 0 to 6 weight percent, the length of an accumulation is not more than 0.1 mm. Therefore, when the amount of atomic mass of the third component selected from Ni, Cr and Al is equal to or less than three times the amount of atomic mass of the second component, the foamed molten metal did not occur. Fe, Co, Ti, In, Rh and Cu can be substituted for Ni, Cr and Al.

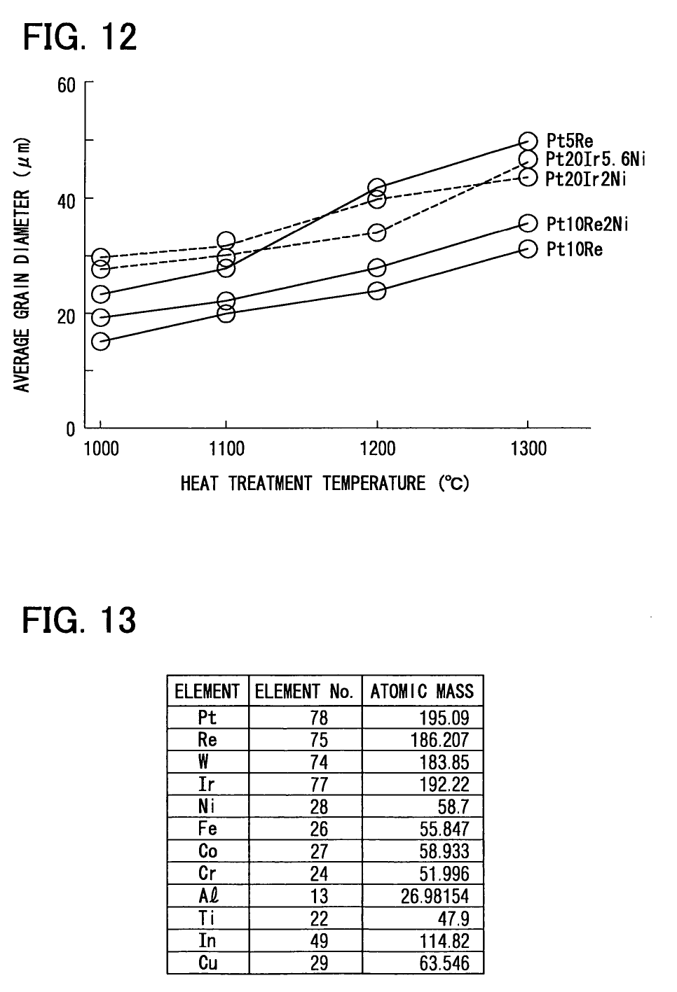

FIG. 12 shows the relationship between the heat treatment temperature and the average grain diameter of Pt-based chip. The average grain diameter can be changed by controlling heat treatment temperature.

While the above particular embodiments of the invention have been shown and described, it will be understood by those who practice the invention and those skilled in the art that various modifications, changes, and improvements may be made to the invention without departing from the spirit of the disclosed concept.

Moreover, except the essential dimensional relationships specified in the previous embodiments, other detailed dimensional ranges and/or relationships may be suitably modified, or changed in designing the spark plugs.

Such modifications, changes, and improvements within the skill of the art are intended to be covered by the appended claims.

Thus, the present invention should not be limited to the disclosed embodiments, but may be implemented in other ways without departing from the spirit of the invention.

1. A spark plug comprising:
a metal shell;
a center electrode secured in the metal shell and isolated from the metal shell;
a ground electrode joined to the metal shell;
a Pt-based chip joined to at least one of confronting portions of the center electrode and the ground electrode; and
wherein the Pt-based chip has a granulated crystal structure and has an average grain diameter in a range from 15 to 45 μm.

2. The spark plug according to claim 1, wherein the Pt-based chip has 100HV0.3 hardness or more.

3. The spark plug according to claim 1, wherein the Pt-based chip includes Pt in an amount of equal to or more than 50 weight percent as a first component and at least one additive selected from Ir, Re and W in a range from 3 to 25 weight percent as a second component.

4. The spark plug according to claim 3, wherein the Pt-based chip further includes at least one additive selected from Ni, Fe, Co, Cr, Al, Ti, In, Rh and Cu as a third component, and an amount of atomic mass of the third component is equal to or less than three times an amount of atomic mass of the second component.

5. The spark plug according to claim 1, wherein
a spark gap formed between the center electrode and the ground electrode is in a range from 0.15 to 0.6 mm.

6. A method of manufacturing a spark plug having a metal shell, a center electrode secured in the metal shell and isolated from the metal shell, a ground electrode joined to the metal shell, a Pt-based chip joined to at least one of confronting portions of the center electrode and the ground electrode comprising:
forming a Pt-based chip having a stratified crystal structure;
recrystallizing the Pt-based chip from the stratified crystal structure to a granulated crystal structure by heat treatment; and
welding the Pt-based chip having the granulated crystal structure to at least one of confronting portions of the center electrode and the ground electrode.

7. The method according to claim 6, wherein
the recrystallizing is conducted in a vacuum or an inactive gas atmosphere.

8. The method according to claim 6, wherein
the Pt-based chip has an average grain diameter in a range from 15 to 45 μm.
